(19) United States
(12) Patent Application Publication
(10) Pub. No.: US 2017/0195222 A1
(43) Pub. Date: Jul. 6, 2017

(54) ROUTING FRAMES IN SHARED MEDIUM NETWORKS

(71) Applicant: QUALCOMM Incorporated, San Diego, CA (US)

(72) Inventor: Sidney Brower Schrum, JR., Ocala, FL (US)

(21) Appl. No.: 14/985,321

(22) Filed: Dec. 30, 2015

(51) Int. Cl. H04L 12/741; H04L 12/823; H04L 12/931; H04L 12/705

(52) U.S. Cl. CPC H04L 45/74; H04L 45/18; H04L 47/32; H04L 49/354

(57) ABSTRACT

A neighbor transmitter identifier that identifies a network interface of a network device that transmitted the frame to a receiving network interface is placed in a frame header. Additionally, an initial transmitter identifier that indicates the network interface of a network device that originally transmitted the frame onto a network segment is placed in the frame header. The neighbor transmitter identifier allows a receiving network device to determine if the communication link over which the frame was received is part of the routing tree. The initial transmitter identifier allows a receiving device to determine a direction along a routing tree that the frame is traversing. The neighbor transmitter identifier and the initial transmitter identifier enable the receiving device to determine if the frame should be forwarded or discarded.

### TECHNICAL FIELD

Aspects of the disclosure generally relate to the field of networking, and, more particularly, to routing frames in networks that include shared medium segments.

### BACKGROUND

Networks can have multiple interconnected network segments such that loops may exist in the network. For example, network segment A may connect with network segment B, which in turn connects to network segment C. If network segment C has a connection to network segment A, a loop is formed. In this case, a frame originating in network A may traverse the network segments A to B to C and back to A. As a result, a frame can endlessly circulate through the network, wasting network and processor resources.

In networks having loops, frames can be successfully delivered without the risk of being replicated and/or endlessly circulating through the network if the frames are routed along loop-free routing trees. A routing tree is a graph of a network topology that indicates network segments in a network and the network devices that communicate via the network segments. A loop-free routing tree can be created by analyzing the network interfaces of network devices that interconnect network segments (e.g., bridges, routers etc.). The routing tree can be used to determine the network interfaces on bridges, routers or access points that are allowed to forward frames. The routing tree can also be used to determine network interfaces that are to be blocked from forwarding frames in order to avoid loops. In addition, forwarding rules may be used to avoid loops. A conventional forwarding rule that can be used with routing trees specifies that forwarding devices can forward received frames out of network interfaces that are not blocked except for the network interface through which the frame was received.

However, creation of a routing tree and application of the conventional forwarding rule above may be insufficient to prevent loops if there is a relay device in one of the network segments. A relay device is a network device that relays (i.e., forwards) frames through the same network interface at which the frame was received. For example, an IEEE 802.11 (“Wi-Fi”) wireless access point (“AP”) operates as a central relay device. The AP receives a frame from a source via a wireless network interface and forwards the frame to connected network devices (i.e., stations) via the same wireless network interface.

Additionally, some network architectures include multiple forwarding devices on the same network segment. The multiple forwarding devices can be used to handle the case where some network devices on the network segment cannot directly communicate with other network devices on the same network segment. The conventional forwarding rule can fail to prevent loops in network architectures where multiple forwarding devices are present on the same network segment. In addition, multiple forwarding devices on the same network segment can result in the same frame being transmitted onto the same network segment more than once. This can result in some or all devices in the network receiving multiple copies of the same frame, which can confuse upper layer network protocols and cause data corruption.

SUMMARY

A frame header of a frame that is transmitted in a network may include a neighbor transmitter identifier and an initial transmitter identifier. The neighbor transmitter identifier identifies a network interface of a network device that transmitted the frame to a receiving network interface. The initial transmitter identifier indicates the network interface of a network device that originally transmitted the frame onto a network segment. The neighbor transmitter identifier allows a receiving network device to determine if a network interface from which the frame was received is part of the routing tree. The initial transmitter identifier allows a receiving network device to determine a direction along a routing tree that the frame is traversing. The neighbor transmitter identifier and the initial transmitter identifier enable the receiving network device to determine if the frame should be forwarded, passed to upper layer network layers for processing, both forwarded and passed to upper network layers for processing, or discarded. If the neighbor transmitter identifier and the initial transmitter identifier indicate that the frame will be forwarded back towards an originator of the frame in the routing tree, the frame is discarded. Also, if the neighbor transmitter identifier indicates that the frame was received from a device that is not an immediate neighbor in the routing tree, the frame is discarded.

### BRIEF DESCRIPTION OF THE DRAWINGS

The aspects of the disclosure may be better understood, and numerous objects, features, and advantages made apparent to those skilled in the art by referencing the accompanying drawings.

FIG. 1 is a block diagram illustrating aspects of a network device.

FIG. 2A is a block diagram illustrating frame header fields.

FIG. 2B is a block diagram illustrating values for the frame header fields during an example forwarding of a frame.

FIG. 3 is a flowchart illustrating operations for filtering frames based on a forwarding direction.

FIG. 4 is a flowchart illustrating operations for determining transmitter identifiers to be inserted into a frame header.

FIG. 5 is a diagram providing a key to symbols used in FIGS. 6-10.

FIG. 6 is a block diagram illustrating an example network including wireless network segments.

FIG. 7 is a block diagram illustrating an example frame flow through the network illustrated in FIG. 6.

FIG. 8 is a block diagram illustrating an example network including powerline communication network segments.

FIG. 9 is a block diagram illustrating an example routing tree for the example network illustrated in FIG. 8.

FIG. 10 is a block diagram illustrating an alternative example routing tree for the example network illustrated in FIG. 8.

### DETAILED DESCRIPTION

The description that follows includes example systems, methods, techniques, instruction sequences and computer program products that describe various aspects of the disclosure. However, it is understood that the described aspects may be practiced without these specific details. In other instances, well-known instruction instances, protocols, structures and techniques have not been shown in detail in order not to obfuscate the description.

In some aspects, a neighbor transmitter identifier and an initial transmitter identifier are added into a frame header prior to transmitting a frame on a network segment. The neighbor transmitter identifier and the initial transmitter identifier can be used individually or together to avoid frame loops in a network and duplicate received frames. The neighbor transmitter identifier can identify a network interface of a network device that transmitted the frame to the receiving network device. The initial transmitter identifier can indicate the network interface of a network device that originally transmitted the frame onto the network segment.

The network device receiving the frame can use the neighbor transmitter identifier to determine if the communication link over which the frame was received is part of a routing tree for the network. The initial transmitter identifier can be used by the receiving network device to determine the direction that the frame is traversing along the routing tree if the receiving device is the initial transmitter. If the receiving device is not the initial transmitter device, then both the initial transmitter identifier and neighbor transmitter identifier can be used to determine the direction that the frame is traversing along the routing tree. A network device that first transmits the frame onto the network segment can add the initial transmitter identifier to the frame header before transmitting the frame onto the network segment. A network device that forwards the frame to at least one other network device on the same network segment from which it was received can include, without modification, the initial transmitter identifier of the network device when it forwards the frame. The neighbor transmitter identifier and the initial transmitter identifier can be used by a receiving network device to determine if the frame should be forwarded, passed to upper layer network layers for processing, both forwarded and passed to upper network layers in the device for processing, or discarded. If the neighbor transmitter identifier and the initial transmitter identifier indicate that the frame will be forwarded “upstream” (e.g., back towards an originator of the frame) in the routing tree, the frame can be discarded. If the neighbor transmitter identifier and the initial transmitter identifier indicate the frame will be forwarded “downstream” in the routing tree (e.g., away from the originator), then the frame can be forwarded and/or passed to upper network layers for processing. In addition, if the neighbor transmitter identifier indicates that the frame was received from a device that is not an immediate neighbor with respect to the routing tree, the frame can be discarded

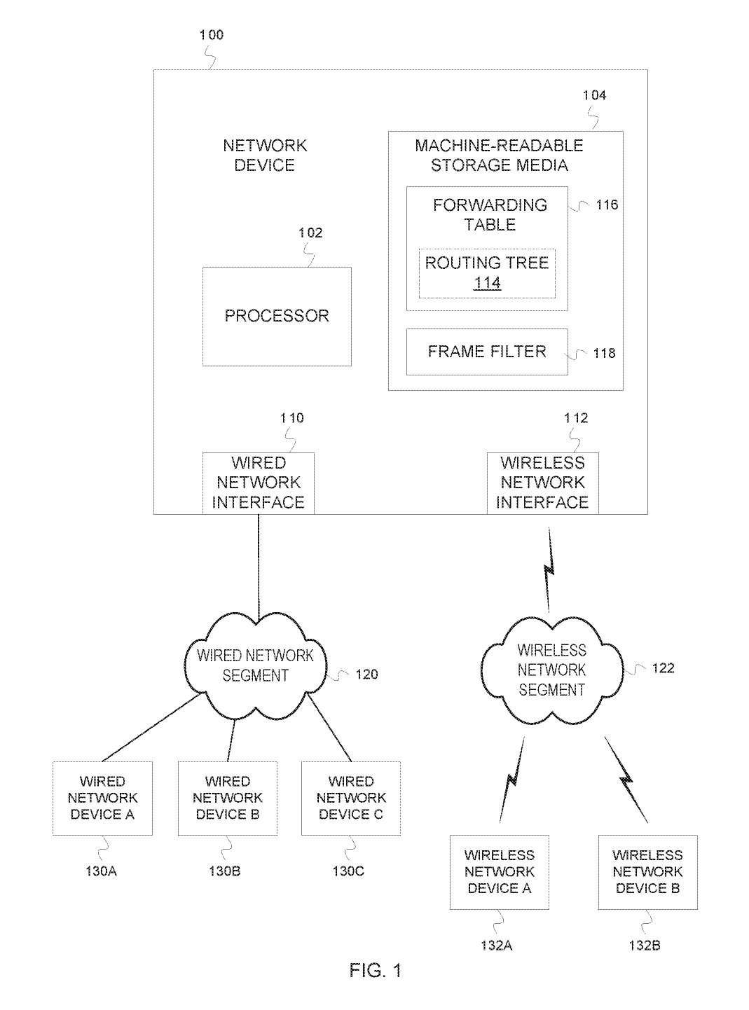

FIG. 1 is a block diagram illustrating aspects of a network device 100. In some aspects, network device 100 can include a processor 102, a machine-readable storage medium 104, and one or more network interfaces (e.g., wired network interface 110 and wireless network interface 112).

Machine-readable storage medium 104 may be used to store one or more of a forwarding table 116, and/or frame filter 118. Forwarding table 116 can include records that have fields that are matched against fields in incoming frames. Example fields include the source and/or destination addresses in the frames and transmitter identifiers. A record can also include data indicating the forwarding/discard actions that can be taken for a particular frame that matches the record. Forwarding table 116 may indicate the neighbor transmitter identifiers of network interfaces of network devices that are immediate neighbors of a network device. Further, the forwarding table 116 can indicate if a given network device has a network interface that is configured as a frame relay network interface for the network segment.

The records in forwarding table 116 can be used by frame filter 118 to implement a routing tree 114. Routing tree 114 is a logical entity that can be defined by the records in forwarding table 116 to describe a loop-free logical topology for a network where the physical topology of the network may include loops. The network device 100 can determine routing tree 114 and can generate data for forwarding table 116 that implements the routing tree 114. Alternatively, a different network device (not shown in FIG. 1) can determine routing tree 114 and generate data for forwarding table 116 that implements routing tree 114. The different network device can communicate the forwarding table 116 to network device 100.

In some aspects, routing tree 114 can be a spanning tree. A spanning tree is a description of a network topology that includes routes between all devices in the network while avoiding loops. The nodes of the spanning tree can be network segments and the network devices that interconnect network segments, such as bridges or routers. The edges of the spanning tree are the network interfaces and communication links that couple the bridges and routers to the network segments. Various methods can be used to generate a spanning tree. For example, the IEEE 802.1D Spanning Tree Protocol (STP) and Rapid Spanning Tree Protocol (RSTP) are distributed algorithms for generating spanning trees. Alternatively, one network device may collect topology information from other network devices in a network and determine a spanning tree based on link-cost methods or other means.

The routing tree 114 may specify a mode of operation for the network interfaces on a network device in the routing tree 114. Two such modes of operation that can be specified are “forwarding” mode and “blocked” mode. Network interfaces that are included in the routing tree 114 can be set to the forwarding mode. Network interfaces in the forwarding mode can forward frames that are received on other network interfaces of the network device. Network interfaces that are not part of the spanning tree can be placed in the “blocked” mode of operation. A network interface that is in the blocked mode of operation can be referred to as a blocked network interface. Frames may not be transmitted out of blocked network interfaces, and frames received through blocked network interfaces may not be forwarded.

As noted above, routing tree 114 may be a spanning tree that spans an entire network. Alternatively, routing tree 114 can be a tree that that does not span the entire network. For example, a routing tree 114 may be a multicast routing tree that spans a subset of the network. A multicast routing tree can be useful for delivering multicast frames to a subset of the network devices defined by a multicast group. In this case, the nodes and edges in the routing tree 114 can represent a group of forwarding devices and network interfaces that are included in a given multicast address or set of multicast addresses.

Further, forwarding table 116 can define multiple independent routing trees (spanning or otherwise) that can be implemented for the same network. The multiple independent routing trees can be used in conjunction with different routing methods. For instance, an independent routing tree may be used with a particular routing method that can be applied to a particular class or classes of frames. As an example, a routing tree 114 may include a high priority routing tree that can be specific to forwarding high priority frames. A separate normal priority routing tree can be used for normal priority frames. Separate network interface information and forwarding/blocking mode information can be maintained for the normal priority routing tree and the high priority routing tree. Alternatively, multiple forwarding tables may be used to define the multiple routing trees.

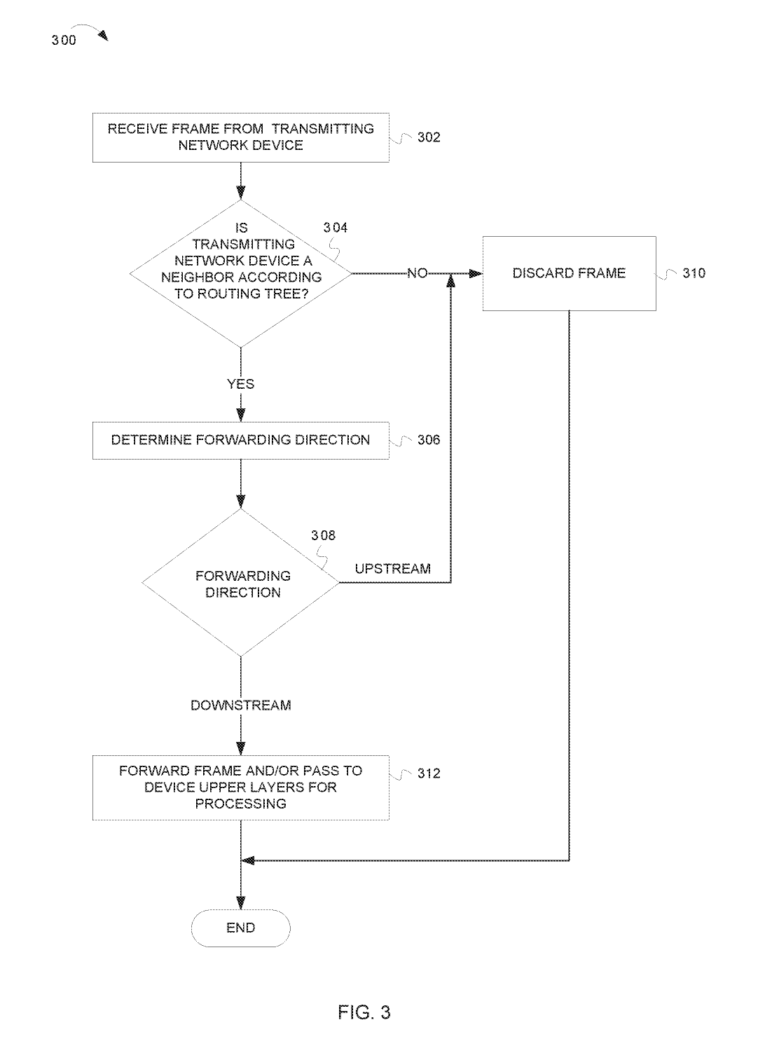

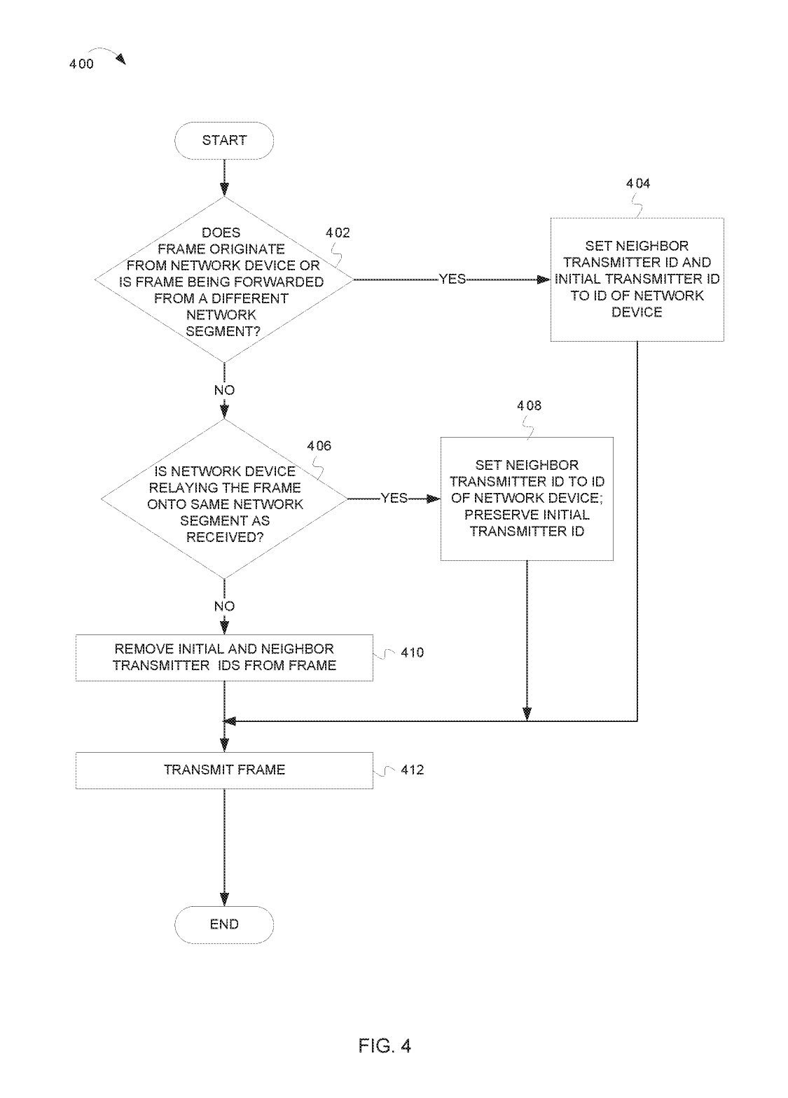

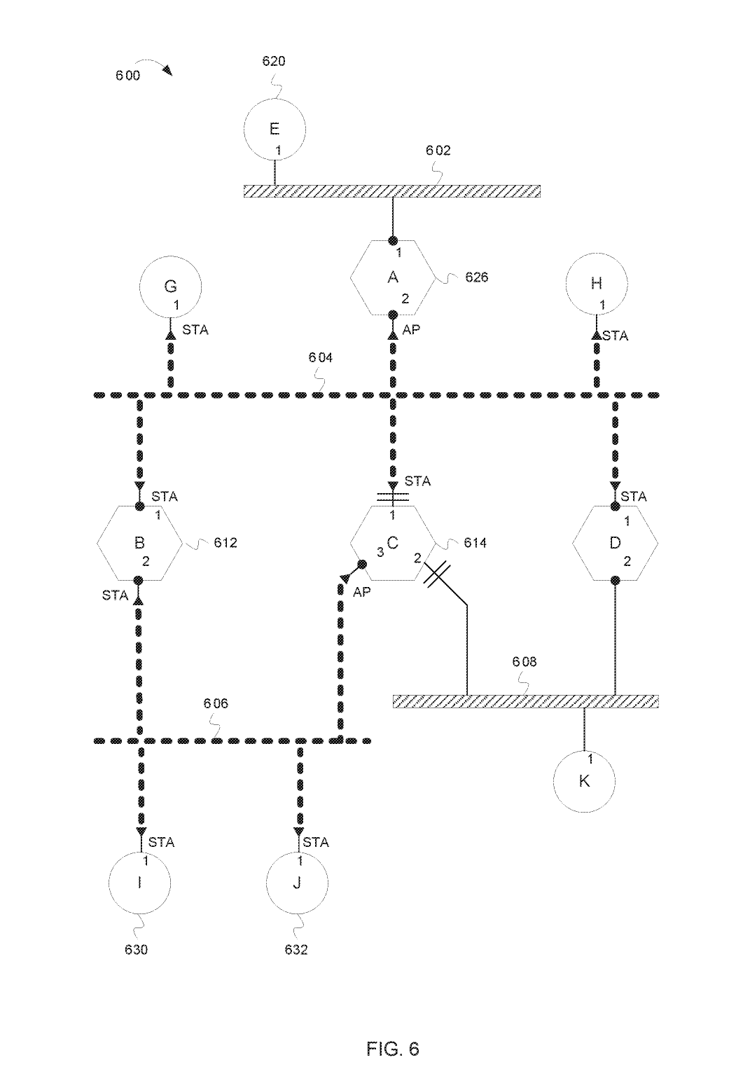

Frame filter 118 can selectively forward or discard frames that are received on a network interface of network device 100 (e.g., wired network interface 110 or wireless network interface 112). Frame filter 118 may use information provided by a frame header in conjunction with records in forwarding table 116 to determine whether to forward, process, both forward and process, or discard a frame. Further details on the operation of frame filter 118 are provided below with respect to FIGS. 3 and 4, and the example networks illustrated in FIGS. 6-10.

Wired network interface 110, when present, may be any type of wired interface communicably coupling network device 100 to wired network segment 120. For example, wired network interface 110 may be an Ethernet interface, a powerline communication (PLC) network interface, or a Multimedia over Coax (MoCA) interface. Network device 100 can communicate with wired network devices (e.g., wired network devices 130A, 130B and 130C) via wired network interface 110. Wired network interface 110 may include a transmitter, receiver, transceiver etc. that can be used to implement a protocol supported by the wired network interface 110. Further, wired network interface 110 may include a processor to implement a protocol.

Wireless network interface 112, when present, may implement any of a variety of wireless network protocols enabling network device 100 to communicate with peer wireless network devices on a wireless network segment 122. For example, wireless network interface 112 may be an IEEE 802.11 wireless local area network (WLAN) interface, a BLUETOOTH® (Bluetooth) interface, a worldwide interoperability for microwave access (WiMAX) interface, a ZigBee® interface, etc. Network device 100 can communicate with wireless network devices (e.g., wireless network devices 132A and 132B) via wireless network interface 112. Wireless network interface 112 may include a transmitter, receiver, transceiver etc. that can be used to implement a wireless protocol supported by the wireless network interface 112. Further, wireless network interface 112 may include a processor to implement a protocol.

In some aspects, network device 100 can function as a bridge that interconnects wired network segment 120 and wireless network segment 122. For example, a frame to be transmitted from wired network device 130A to wireless network device 132B may be routed through network device 100. After transmission by wired network device 130A, the frame may be received by wired network interface 110. Frame filter 118 can determine if the frame should be discarded or forwarded. If the frame is to be forwarded, it is transmitted on wireless network segment 122 via wireless network interface 112. Wireless network device 132B can then receive the frame from the wireless network segment 122.

It should be noted that a network device 100 can include a single network interface (e.g., one of wired network interface 110 or wireless network interface 112). Further, a network device 100 may include two or more network interfaces. For example, network device 100 may include multiple instances of wired network interface 110 or wireless network interface 112 that can communicably couple network device 100 to multiple network segments. The multiple network segments may be the same or different types of networks and may use the same or different protocols.

Processor 102 may be any type of processor (possibly including multiple processors, multiple cores, and/or implementing multi-threading, etc.). While the functionality of the various aspects of the disclosure may be executed, at least in part, by the processor 102, the functionality may be implemented with an application specific integrated circuit, in logic implemented in the processor 102, in a co-processor on a peripheral device or card, etc.

Machine-readable storage medium 104 may be a memory such as random access memory (RAM), static RAM (SRAM), dynamic RAM (DRAM), zero capacitor RAM, Twin Transistor RAM, enhanced DRAM (eDRAM), extended data out (EDO RAM), double data rate RAM (DDR RAM), electrically erasable programmable read-only memory (EEPROM), non-volatile RAM (NRAM), resistive RAM (RRAM), silicon-oxide-nitride-oxide-silicon (SONOS), phase-change RAM (PRAM), etc.). Additionally, machine-readable storage medium 104 may be a magnetic storage medium (e.g., hard drive, floppy diskette); optical storage medium (e.g., compact disk- read only memory (CD-ROM), digital versatile disk ROM (DVD-ROM)); magneto-optical storage medium; flash memory; or other types of non-transitory media suitable for storing electronic instructions.

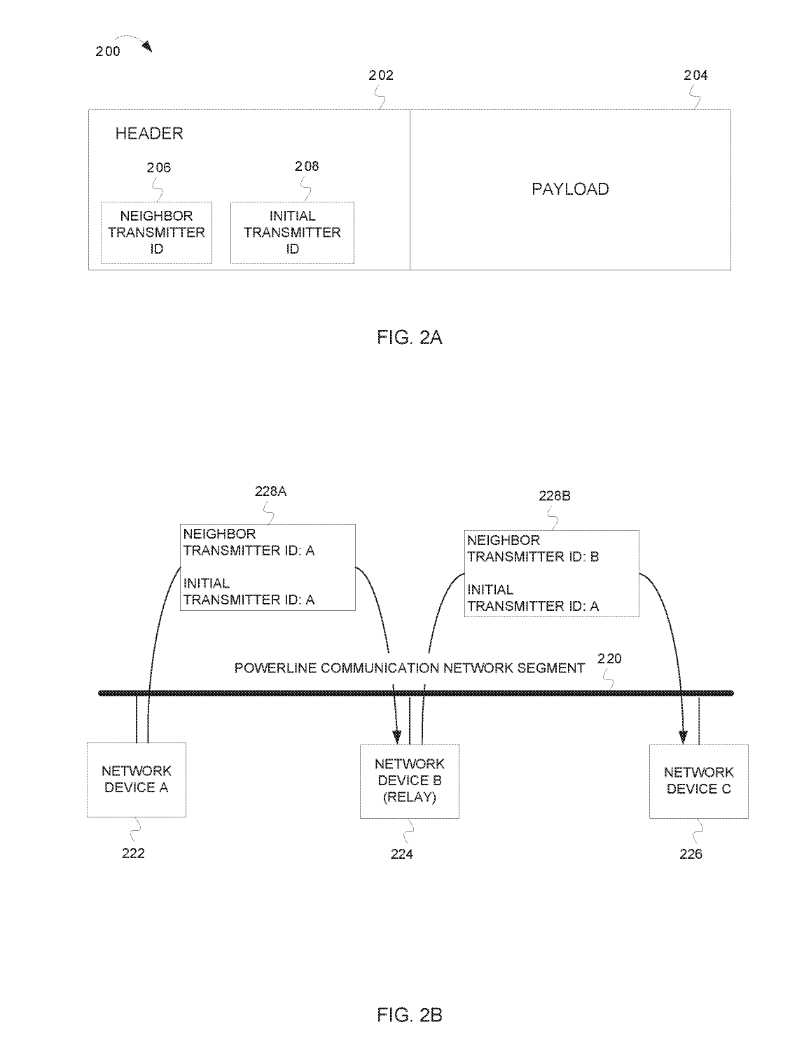

FIG. 2A is a block diagram illustrating frame header fields of a frame 200 according to aspects of the disclosure. Frame 200 may include a frame header 202 and a payload 204. Payload 204 comprises data to be delivered to a corresponding network layer of a destination network device specified in the frame header 202.

The frame header 202, in some aspects, can include a neighbor transmitter identifier (ID) 206 and an initial transmitter ID 208. The frame header 202 can include other fields that can be used to transmit the payload 204 to a destination network device. However, these additional fields are not included in FIG. 2 to avoid obfuscating the disclosure.

The neighbor transmitter ID 206 can identify the network interface of a network device that transmitted a frame to the network device receiving the frame. The neighbor transmitter ID 206 can be a unique value assigned to the network interface that transmits a frame onto the network. In some aspects, a neighbor transmitter ID 206 need only be unique among the network interfaces attached to the same network segment. The value assigned to a particular device can be the same as the value assigned for initial transmitter identifiers. In some aspects, the neighbor transmitter ID 206 can be a network interface address. As an example, the network interface address can be a media access and control (MAC) address, a network device ID, or other type of address or identifier. A network protocol may already define a field that can be used for the neighbor transmitter ID 206. For example, in the HomePlug AV PLC network protocol, a “source TEI” field indicates which network interface transmitted the frame. Another example is the “transmitter address” field in the IEEE 802.11 (“Wi-Fi”) protocol, which indicates the AP that transmitted the frame. If the information is not by default included in transmitted frames, then a network device 100 can add a neighbor transmitter ID 206 to a frame transmitted by the network device 100. In alternative aspects, the neighbor transmitter ID 206 can be indicated in a virtual local area network (VLAN) tag that can be included in a frame. The frame filter 118 can use the neighbor transmitter ID 206 to determine if the communication link over which the frame was received is part of the routing tree 114.

In some environments, a network segment may utilize a single relay that operates as a central relay device. The non-relay devices on the network segment can unicast all frames, including broadcast and multicast frames, to the relay device, which then relays the frames to the appropriate devices on the network segment, In such environments, the neighbor transmitter ID 206 does not have to be included in transmitted frames because all frames received over the network by non-relay devices are known a priori to be transmitted by the central relay device. For example, IEEE 802.11 networks can utilize a single central relay (the AP). However, the AP can include an identifier (the transmitter address field) in frames transmitted by the AP that functions as a neighbor transmitter ID. Thus, stations can use the transmitter address field to determine that frames were transmitted by the AP.

The initial transmitter ID 208 can identify the network interface that first transmitted the frame onto a particular network segment. In some aspects, the initial transmitter ID 208 can be a field that can be added to frame header 202. The initial transmitter ID 208 can be a unique value assigned to the network interface. In some aspects, an initial transmitter ID 208 need only be unique among the network interfaces attached to the same network segment. The value assigned to a particular device can be the same as the value assigned for neighbor transmitter IDs. For example, the initial transmitter ID 208 can be a MAC address, a network device ID, or other type of address or identifier of the network interface of the network device that initially transmitted the frame onto the network segment. In alternative aspects, the initial transmitter ID 208 can be a VLAN tag where the tag comprises a unique value assigned for a network interface of a network device that may forward frames onto the network segment. In a further alternative aspect, the initial transmitter ID 208 can indicate a network interface of a neighbor network device of the neighbor transmitting network device (i.e., the previous “hop” in the network to the transmitting neighbor network device). The frame filter 118 can use the initial transmitter ID 208 to determine the direction along the routing tree 114 that the frame is traversing.

FIG. 2B is a block diagram illustrating values for the frame header fields during an example forwarding of a frame. In the example illustrated in FIG. 2B, network device 222, network device 224, and network device 226 are communicably coupled to a PLC network segment 220. In the example, network device 222 cannot communicate directly with network device 226 due to interference in the PLC network segment 220. However, network device 224 can reliably communicate with network device 226. Thus, in the example, a network interface of network device 224 has been configured as a frame relay network interface to relay frames transmitted by network device 222 to network device 226.

Frame headers 228A and 228B show the values of the neighbor transmitter ID 206 and initial transmitter ID 208 for a frame that is transmitted and forwarded through PLC network segment 220. Network device 222 sets both the neighbor transmitter ID 206 and the initial transmitter ID 208 in frame header 228A to an identifier associated with network device 222. For example, the neighbor transmitter ID 206 and the initial transmitter ID 208 may be set to a MAC address for network device 222.

Network device 224 receives the frame transmitted by network device 222. Because its network interface has been configured as a frame relay network interface, network device 224 forwards the frame to network device 226. Network device 224 creates frame header 228B for the frame, and sets the neighbor transmitter ID 206 to an identifier associated with network device 224 (e.g., a MAC address for network device 224). Network device 224 does not modify the initial transmitter ID 208 in frame header 228B because network device 222 was the initial transmitter of the frame onto the PLC network segment 220.

If network device 226 is the destination network device for the frame, network device 226 can receive and process the frame. If network device 226 is a router or a bridge, a frame filter 118 on network device 226 can use the values for the neighbor transmitter ID 206 and initial transmitter ID 208 to determine whether the frame should be forwarded or discarded.

FIG. 3 is a flowchart 300 illustrating operations for filtering frames based on a forwarding direction according to aspects of the disclosure.

At block 302, a network device 100 receives a frame from a transmitting network device.

At block 304, the frame filter 118 determines if the transmitting network device is an immediate neighbor network device according to a routing tree 114. Note that a transmitting network device can be a physical neighbor network device to the receiving network device, but for frame forwarding purposes, the transmitting network device may not be considered an immediate neighbor network device to a receiving network device. For example, the transmitting network device and the receiving network device can be on the same network segment and can directly communicate with one another. However, if the routing tree 114 does not indicate that the transmitting network device is an immediate neighbor network device, then at block 304, a frame filter 118 of the receiving network device can determine that the transmitting network device is not an immediate neighbor network device. Thus at block 304, the frame filter 118 determines whether the routing tree 114 considers the transmitting network device to be an immediate neighbor network device. As an example, there can be multiple forwarding devices having network interfaces that are members of the same network and that are part of the routing tree 114. However, not all network interfaces of the forwarding devices may be immediate neighbors with respect to the routing tree 114. For example, some network interfaces of the forwarding devices may be blocked. Thus, the routing tree 114 is used to determine whether a forwarding device is an immediate neighbor network device. The physical topology of the network may not be a determining factor as to whether a network device is an immediate neighbor network device.

If at block 304 the frame filter 118 determines that the transmitting network device is not an immediate neighbor network device for forwarding purposes, then at block 310, the frame filter 118 discards the frame. That is, the frame filter 118 does not forward the frame via any network interface on the receiving network device. The method then ends.

If at block 304 the frame filter 118 determines that the transmitting network device is an immediate neighbor network device, then at block 306, the frame filter 118 determines a forwarding direction for the frame. In some aspects, the frame can be forwarded in an upstream direction or a downstream direction with respect to the routing tree 114. In this disclosure, downstream is used to describe a frame forwarding direction that is away from the network interface that originally transmitted the frame onto a network segment. Upstream is used to describe a frame forwarding direction that is towards the network interface that originally transmitted the frame. In some aspects, the frame filter 118 utilizes the initial transmitter ID 208 in the frame header 202 of the received frame to determine a forwarding direction. If the initial transmitter ID 208 in the received frame matches the initial transmitter ID 208 assigned to the network interface receiving the frame, then the receiving network device was the original transmitter of the frame onto the network segment. In this case, the forwarding direction is upstream (i.e., the frame is being forwarded in the opposite direction to its original forwarding direction). Therefore, the frame is considered a loopback frame. If the initial transmitter ID 208 in the received frame does not match the initial transmitter ID 208 assigned to the network device receiving the frame, then the initial transmitter ID 208 and neighbor transmitter ID 206 can be used to determine the direction that the frame is traversing along the routing tree 114. A receiving device can determine from the neighbor transmitter ID 206 the link in the routing tree 114 over which the frame is received, and therefore the relative direction of the received frame. Then, based on the initial transmitter ID 208,the topology of the routing tree 114, and the relative location of the initial transmitters in the routing tree 114, the receiving device can determine if the received frame is traversing the routing tree 114 toward the initial transmitter or away from the initial transmitter. If the direction is toward the initial transmitter, then the received frame is in an upstream direction (i.e. the frame is being forwarded in the opposite direction to its original forwarding direction). In this case, the frame can be considered a loopback frame and can be discarded.

At block 308, frame filter 118 uses the forwarding direction to determine whether to forward or discard the frame. If the frame is being forwarded upstream, then the method proceeds to block 310, where the frame filter 118 discards the frame.

Alternatively, if at block 306 the frame filter 118 determines that the frame is being forwarded downstream, then at block 312, the frame filter 118 forwards the frame and/or passes the frame upper layers on the device for processing. For example, if the frame is a broadcast or multicast frame that includes the network device 100 as an intended recipient, the frame is passed to the upper layers of the network device 100 for processing. In addition, if network device 100 is configured as a forwarding device, the frame and can be forwarded on to other network devices.

It should be noted that the method described above in FIG. 3 can be combined with other forwarding rules. For example, the method described above can be combined with the conventional forwarding rule that specifies that a frame can be transmitted out of all network interfaces of a forwarding device except the interface that received the frame.

FIG. 4 is a flowchart 400 illustrating operations for determining transmitter identifiers to be used for the neighbor transmitter ID 206 and the initial transmitter ID 208 in a frame header 202 according to aspects of the disclosure. The operations illustrated in flowchart 400 can be performed by a network device (e.g., network device 100) that is preparing to transmit a frame onto a network segment.

At block 402, the network device 100 determines if the frame will originate from network device 100, or if the frame is being forwarded from a different network segment through network device 100. That is, the network device 100 determines if it is the original creator of the frame for transmission on the network segment on which the frame will be transmitted.

If the frame will originate on the network segment with network device 100, then at block 404, the network device 100 sets the neighbor transmitter ID 206 and the initial transmitter ID 208 in the frame header of the frame to be transmitted to the network device ID associated with the network device 100. The method then proceeds to block 412, where the frame is transmitted on the network segment.

At block 406, the network device 100 determines if the frame is being forwarded to the same network segment from which the frame was received.

If the frame is being forwarded to the same network segment, then at block 408, the network device 100 sets the neighbor transmitter ID 206 in the frame header of the frame to be transmitted to the network device ID associated with the network device 100. The network device 100 copies the initial transmitter ID 208 from the received frame to the frame to be transmitted. The method then proceeds to block 412, where the network device 100 transmits the frame. Therefore, if the frame is being forwarded to the same network segment, the initial transmitter ID 208 in the frame header 202 is not modified by the network device 100. Thus, the initial transmitter ID 208 retains the same value it had when the frame was received by the network device 100.

If the frame is being forwarded to a different network segment than the network segment on which the frame was received by the network device 100, then at block 410, the network device 100 removes the neighbor transmitter ID 206 and the initial transmitter ID 208 in preparation for transmitting the frame onto a different network segment. Note that if the network segment that the frame is forwarded to utilizes loopback frame and duplicate frame filtering management as disclosed herein, then the neighbor transmitter ID 206 and initial transmitter ID 208 for the network segment are added to the frame consistent with block 402 and block 404 in the flowchart prior to transmitting the frame on the different network segment.

The method then proceeds to block 412, where the network device 100 transmits the frame with the modified frame header.

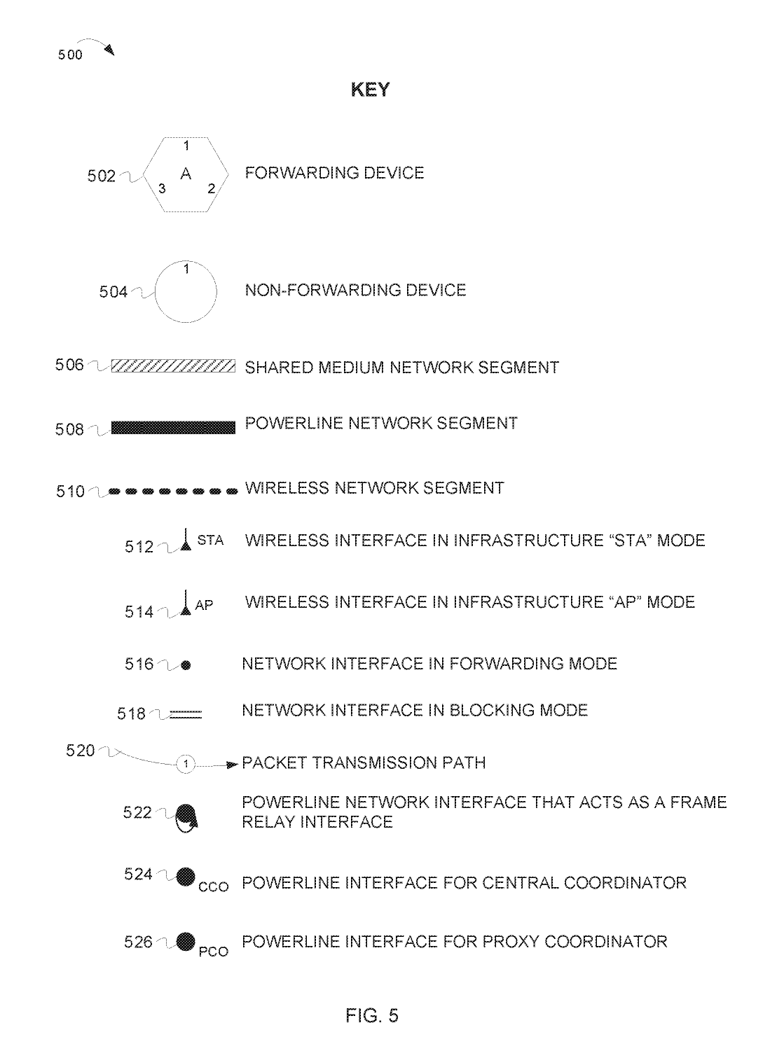

FIG. 5 is a diagram providing a key 500 to symbols used in FIGS. 6-10.

Symbol 502 represents a forwarding device. A forwarding device can be a network device that can forward frames from one network interface to the same or network interface (relay) another network interface. Examples of such network devices include bridges, routers, etc. Specific instances of a forwarding device are identified in the figures using letters “A”-“D.” A specific instance of a network interface (also referred to as a port) on a forwarding device is identified using the numbers 1-9. Thus, in the example illustrated in key 500, symbol 502 represents a forwarding device having three network interfaces. In the examples illustrated in FIGS. 6-10, a particular network interface may be referred to by the letter identifying the forwarding device and the numeric identifier associated with the network interface. For example, the third network interface of forwarding device “A” may be referred to as network interface “A.3.”

Symbol 504 represents a non-forwarding device. A non-forwarding device can be a network device that does not forward frames between its network interfaces (i.e., an “end” network device or “leaf” network device). Specific instances of non-forwarding devices will be identified using letters “E”-“K.” Further, specific network interfaces on a non-forwarding device will be identified using numbers. It should be noted that it is possible for non-forwarding devices to implement more than one network interface. For example, in order to provide increased throughput or reliability, a non-forwarding device may implement two or more network interfaces. In the case that one network interface fails, a different network interface can take over for the failed network interface. Alternatively, a non-forwarding device may provide multiple network interfaces where the non-forwarding device is not configured to route frames between the multiple network interfaces. For example, a conventional mobile phone typically has two different wireless network interfaces. A first network interface can communicably couple the mobile phone to a mobile phone network. A second network interface can communicably couple the mobile phone to a wireless network. However, the mobile phone is not typically configured to forward frames between the two network interfaces. Thus, in order to avoid obfuscating the disclosure, non-forwarding devices with more than one network interface are not shown in the example networks illustrated in FIGS. 6-10.

Symbol 506 represents a wired shared medium segment. A shared medium segment can be a wired sub-network of a larger network comprising multiple network segments. In some network technologies, all of the network devices on the shared medium segment receive a frame when it is transmitted. For other network technologies in which partial connectivity can occur (e.g., where devices can be members of the same network segment but may not be able to directly communicate with each other), the shared medium segment includes all devices that are able to directly communicate with a particular transmitter to receive frames transmitted by the particular transmitter. The network device then determines if it is the intended destination of the frame, and if so, processes the frame. An example of a shared medium segment can be an Ethernet network segment. Another example of a shared medium segment can be a PLC network segment. A further example of a shared medium segment can be a MoCA network segment.

Symbol 508 represents a PLC network segment, which is a particular type of shared medium segment.

Symbol 510 represents an IEEE 802.11 wireless network segment. The wireless network segment may include devices that communicate via a particular network interface of an access point.

Symbol 512 represents an IEEE 802.11 wireless network interface in infrastructure station (“STA”, i.e., non-access point) mode of operation.

Symbol 514 represents a IEEE 802.11 wireless network interface in infrastructure access point (“AP”) mode of operation

Symbol 516 indicates a network interface that is in forwarding mode. That is, the network interface is included in a routing tree 114 as a forwarding network interface.

Symbol 518 indicates a network interface that is in blocked mode. The network interface may be included in topology data that describes the network and an operational mode (i.e., forwarding or blocked) of the network interfaces that are part of the network. However, a blocked network interface is not included in a routing tree 114.

Symbol 520 represents a path that a frame takes through a network, potentially via multiple network segments. A number in a circle identifies a particular path from a first network interface to a second network interface. Some network interfaces may provide for multiple paths to network devices on a network segment. For example, an IEEE 802.11 wireless network interface that is in an access point mode of operation can provide a path for each wireless network device communicating via the wireless network interface.

Symbol 522 represents a PLC network interface that operates as a frame relay network interface on a PLC network segment. A frame relay network interface can be a network interface that transmits a frame out of the same network interface through which it was received.

Symbol 524 represents represent a network interface for a central coordinator network device on a PLC network segment.

Symbol 526 represents a network interface for a proxy coordinator network device on a PLC network segment.

FIGS. 6-10 illustrate aspects of the disclosure with reference to example networks.

FIG. 6 is a block diagram illustrating an example network 600 including wireless network segments. Example network 600 includes multiple network segments, including a shared medium segment 602, wireless network segment 604, wireless network segment 606, and shared medium segment 608. Forwarding device A 626 can be a bridge that interconnects shared medium segment 602 and wireless network segment 604. Forwarding device B 612 can be a bridge that interconnects wireless network segment 604 and wireless network segment 606. Forwarding device C 614 can be a bridge that interconnects wireless network segment 604 with shared medium segment 608. Non-forwarding device E 620 can be communicably coupled to shared medium segment 602. Non-forwarding device I 630 and non-forwarding device J 632 can be communicably coupled to wireless network segment 606.

Network interface A.2 of forwarding device A 626 can be an IEEE 802.11 wireless access point. IEEE 802.11 infrastructure wireless networks use a wireless access point as a central relay device to deliver frames within a wireless network segment. As noted above, the term “relay” refers to transmitting a frame out of the same network interface through which it was received.

The manner in which frames are delivered in wireless network segments can be described using a local logical topology of the wireless network segments. With infrastructure wireless networks (e.g., wireless network segment 604 and wireless network segment 606), there can be a logical unidirectional point-to-point communication link from an STA network interface to the AP network interface. There can also be a logical unidirectional point-to-point communication link from the AP network interface to an STA network interface for transmitting unicast frames. Further, there can be a single logical unidirectional point-to-multipoint communication link from the AP network interface to a STA network interface for transmitting broadcast and multicast frames.

An example frame traversal through the example network 600 will now be presented. In the example frame traversal, a frame transmitted by non-forwarding device E 620 to non-forwarding device J 632 can be transmitted on shared medium segment 602, and received by network interface A.1. Forwarding device A 626 forwards the frame by transmitting the frame onto wireless network segment 604 via wireless network interface A.2. Forwarding device B 612 receives the frame via network interface B.1 and forwards the frame onto wireless network segment 606 via network interface B.2. Non-forwarding device J 632 receives the frame via network interface J.1.

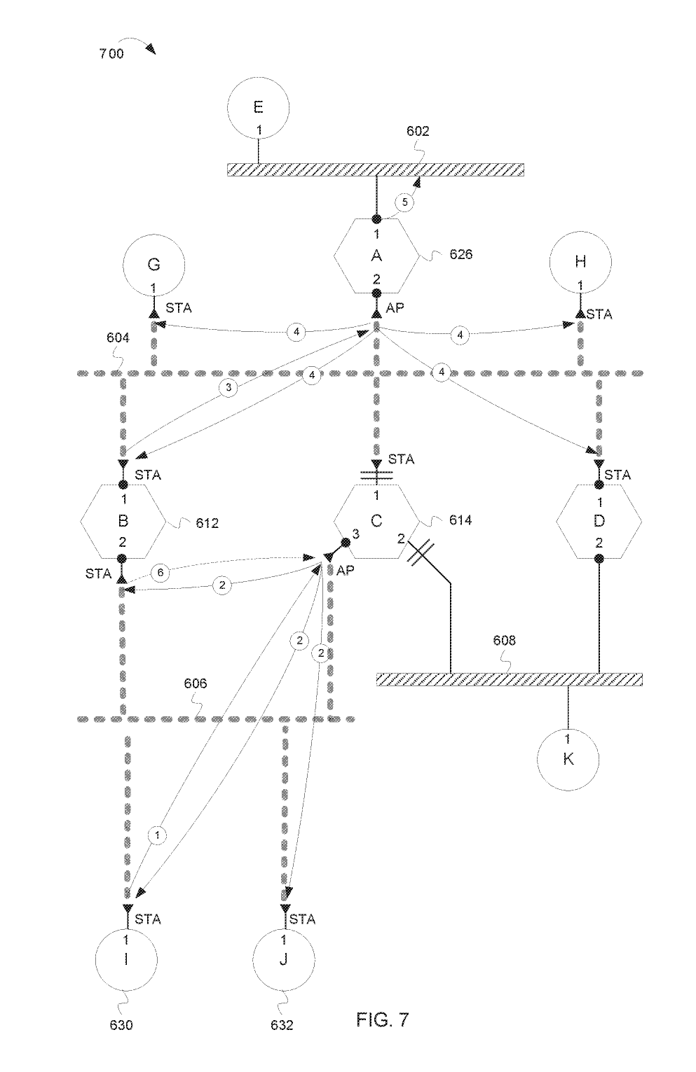

FIG. 7 is a block diagram illustrating an example frame flow 700 through the example network illustrated in FIG. 6. In addition to the components described above with reference to FIG. 6, FIG. 7 includes paths 1-6. Paths 1-6 are used to illustrate the example frame flow 700 and represent transmission and reception of the frame as the frame traverses the example network 600 of FIG. 6.

In the example frame flow illustrated in FIG. 7, non-forwarding device I 630 initiates transmission of a broadcast frame that is to be transmitted to all of the network devices in the network. Broadcasting a frame to all of the network devices in a network can be referred to as flooding the network.

In this example, non-forwarding device I 630 first transmits the broadcast frame via path 1 using a unicast Receive Address (RA) so that it can be received through the wireless network interface C.3 on forwarding device C 614. Forwarding device C 614 then broadcasts the frame onto wireless network segment 606 (illustrated as multiple instances of path 2). Forwarding device B 612 receives the frame through its wireless network interface B.2. Using the conventional forwarding rule, forwarding device B 612 transmits the frame out every network interface that is part of the routing tree 114 (i.e. every network interface that is in a forwarding mode), except the interface from which it was received, unless the interface is designated as a relay interface in the routing tree. If the interface is designated as a relay interface, the frame is also forwarded out the interface on which it was received. Therefore, in the example illustrated in FIG. 7, the frame is transmitted out of network interface B.1 on forwarding device B 612. Thus, the frame can be transmitted via path 3 to the network interface A.2 operating in AP mode in forwarding device A 626. Forwarding device A 626 then broadcasts the frame on wireless network segment 604 (illustrated as multiple instances of path 4). Forwarding device A 626 also forwards the frame to shared medium segment 602 through network interface A.1 (illustrated as path 5).

If constrained to the conventional forwarding rule, when forwarding device A 626 broadcasts the frame over wireless network segment 604, forwarding device B 612 receives the frame over interface B.1. Using the conventional forwarding rule, forwarding device B 612 transmits the frame through interface B.2 to interface C.3 of the forwarding device C 614 via path 6. At this point, a loopback has occurred because the frame is “looped back” to a network device that has previously seen the frame. The same loopback situation occurs on wireless network segment 606 through forwarding device B 612, resulting in the frame circulating endlessly through the network. As a result, network devices on wireless network segment 606 and other network segments may receive an infinite number of copies of the frame.

However, frame filter 118 can be used to prevent the looping and endless circulation of broadcast or multicast frames. In this example, frame forwarding along the routing tree 114 can be accomplished if forwarding device B 612 discards frames it previously forwarded onto wireless network segment 604. Using the method illustrated in FIG. 3, a frame filter 118 on forwarding device B 612 can compare the initial transmitter ID 208 field of the frame received via path 4 with the network interface address of the network interface receiving the frame. The results of the comparison can be used to determine that an attempt is being made to forward the frame in an upstream direction (i.e., back toward the network device that initially transmitted the frame onto the network segment). This is because forwarding device B 612 originally transmitted the frame onto wireless network segment 604. In response to determining that the current forwarding direction is upstream, forwarding device B 612 can discard the frame, thereby avoiding the loopback and resultant endless circulation of the frame.

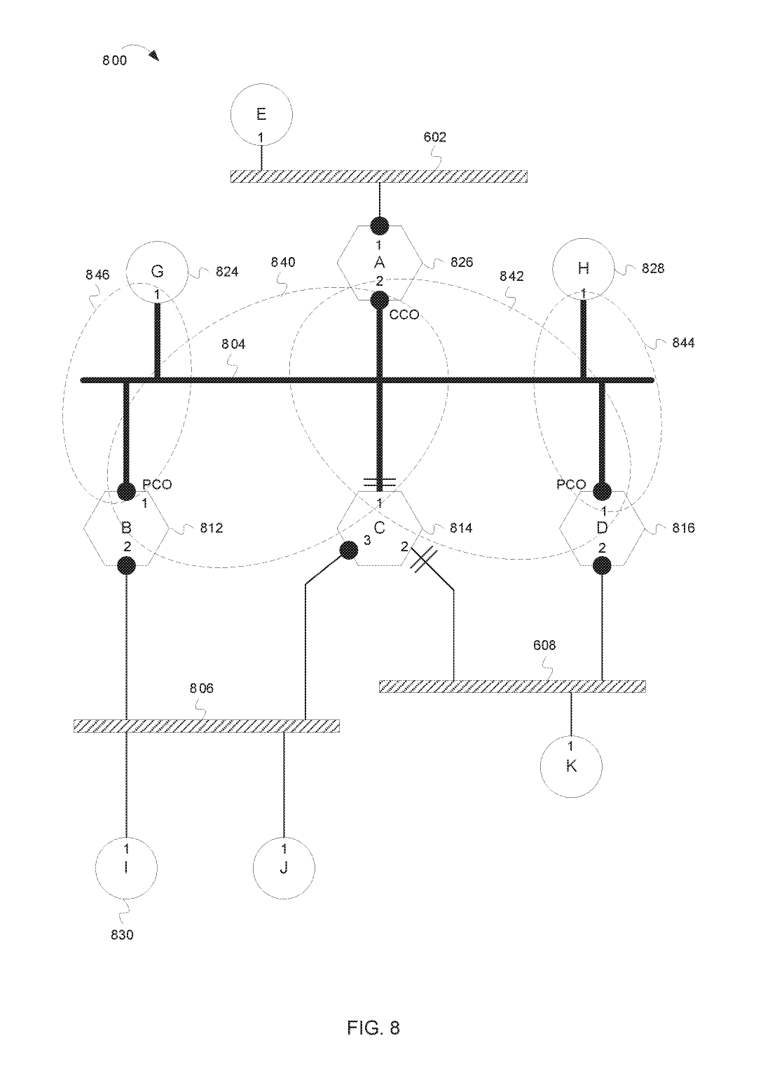

FIG. 8 is a block diagram illustrating an example network 800 including PLC network segments. FIG. 8 illustrates frame forwarding issues that can occur when a network device has a network interface that has been configured as a frame relay network interface. The example network 800 shown in FIG. 8 has the same general topology as the example network 600 shown in FIG. 6, except that wireless network segment 604 has been replaced by PLC network segment 804 and wireless network segment 606 has been replaced with shared medium segment 806. Forwarding device A 826 interconnects PLC network segment 804 with shared medium segment 602. Forwarding device B 812 interconnects PLC network segment 804 with shared medium segment 806. Forwarding device C 814 interconnects PLC network segment 804 with shared medium segment 806. Forwarding device D 816 interconnects PLC network segment 804 with shared medium segment 608. Non-forwarding device G 824 and non-forwarding device H 828 can be communicably coupled to PLC network segment 804. Non-forwarding device I 830 can be communicably coupled to shared medium segment 806.

With PLC networks and other types of networks, it is possible for network devices to be members of the same network segment, but not be able to communicate directly. This may be referred to as the “hidden station” problem because network devices that cannot communicate with one another are in effect hidden from one another. Network segments with hidden stations may also be described as having indeterminate quality communication links (e.g., communication links may be poor, or non-existent, or varying), having unreliable communication links, or experiencing partial connectivity (i.e., there may be network devices in a network segment that cannot directly communicate).

In the example illustrated in FIG. 8, sets of network devices that can reliably communicate with one another via PLC network segment 804 are enclosed within dashed lines. Thus, non-forwarding device G 824 and forwarding device B 812 can reliably communicate with one another as indicated by dashed oval 846. Further, forwarding device A 826, forwarding device B 812 and forwarding device C 814 can reliably communicate with one another as indicated by dashed oval 840. In addition, forwarding device A 826, forwarding device C 814, and forwarding device D 816 can reliably communicate with one another as indicated by dashed oval 842. Finally, forwarding device D 816 and non-forwarding device H 828 can reliably communicate with one another as indicated by dashed oval 844. In the example illustrated in FIG. 8, network devices on PLC network segment 804 that are not within the same dashed oval cannot reliably communicate with one another.

While partial connectivity and/or hidden stations may not be typical of PLC networks, this problem can and does occur in some situations. The example network 800 shown in FIG. 8 illustrates a possible case of hidden stations, partial connectivity and unreliable communication links. For example, non-forwarding device G 824 cannot directly communicate with non-forwarding device H 828. As a result, non-forwarding device G 824 is a hidden station with respect to non-forwarding device H 828. Similarly, non-forwarding device H 828 is a hidden station with respect to non-forwarding device G 824. For this type of situation, frame relaying can be used to insure that network devices that are members of a network segment can communicate using the communication links available in the network segment. In some aspects, frame relaying can be implemented at the bridging layer of a network protocol. Alternatively, frame relaying can be implemented as a hybrid networking abstraction layer of a network protocol and therefore is potentially usable with any underlying networking technology. Frame relaying is typically useful in network segments that experience partial connectivity and/or unreliable communication links.

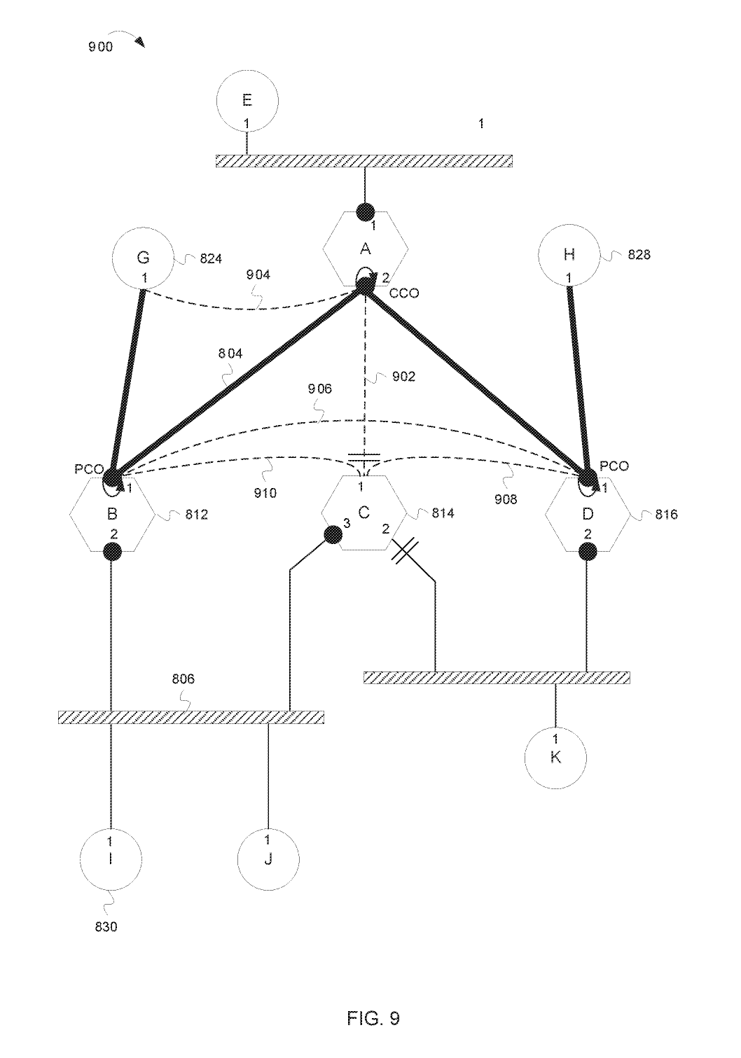

FIG. 9 is a block diagram illustrating an example routing tree 900 for the example network 800 of FIG. 8. In FIG. 9, the physical network topology of example network 800 is shown as it would appear in an example routing tree 900 created from the physical network topology. In addition to the components illustrated in FIG. 8, FIG. 9 illustrates communication links 904, 906, 908 and 910. Communication links 904, 906, 908 and 910 are shown using dashed lines to illustrate that the communication links are present in the physical network topology of example network 800, but are not part of the example routing tree 900 created from example network 800.

For the example network 800, complete connectivity may be achieved in spite of the presence of hidden stations if certain network interfaces on forwarding devices are configured as frame relay network interfaces.

In one possible configuration, network interface B.1 can be configured as a frame relay network interface for frames to and from non-forwarding device G 824. Network interface A.2 can be configured as a frame relay network interface to forward frames to and from network interfaces B.1 and D.1. Network interface D.1 can be configured as a frame relay network interface to forward frames to and from non-forwarding device H 828.

While configuring network interfaces as frame relay network interfaces can reduce or eliminate the problem of hidden stations, broadcast frames that are forwarded by frame relay network interfaces can cause similar problems as those that can occur with the access points or other central relay devices in wireless network segments. For example, a broadcast frame transmitted by non-forwarding device I 830 can be forwarded onto PLC network segment 804 by network interface B.1. Network interface A.2 forwards the frame so that network interface C.1 can receive the frame. However, in so doing, network interface B.1 also receives a copy of the frame because PLC network segment 804 is a shared medium segment. If the conventional forwarding rule is used, then forwarding device B 812 forwards a copy of the frame onto shared medium segment 806, the network segment where the frame originated. As a result, the frame can be a loopback frame that may circulate endlessly through the network.

The method described above with respect to FIG. 3 can be used by a frame filter 118 to eliminate the loopback frame. In this example, frame relay network interface B.1 of forwarding device B 812 originally transmitted the frame onto PLC network segment 804. Thus, an initial transmitter ID 208 of the frame can be set to the network device identifier of forwarding device B 812. When frame relay network interface A.2 of forwarding device A 826 forwards the frame back on to PLC network segment 804, it is received by forwarding device B 812 on network interface B.1. A frame filter 118 on forwarding device B 812 can compare the initial transmitter ID 208 in the received frame and determine that it matches the network device identifier of forwarding device B 812. Thus forwarding device B 812 can determine that the frame is being forwarded back to the originating network device and thus being forwarded in an upstream direction. As a result, the frame filter 118 on forwarding device B 812 can discard the frame, thereby avoiding creation of a loopback frame.

Continuing with the example, when forwarding device D 816 relays the frame onto PLC network segment 804 so that non-forwarding device H 828 receives a copy according to the example routing tree 900, forwarding device A 826 receives a copy of the frame. Forwarding device A 826 can determine from the neighbor transmitter ID 206 that the frame was received from forwarding device D 816 and can determine from the initial transmitter ID 208 that the received frame is traversing the example routing tree 900 in the direction toward the initial transmitter, forwarding device B 812. Forwarding device A 826 can therefore determine the frame is a loopback frame and that the frame can be discarded.

The method described above with respect to FIG. 3 can also be used by a frame filter 118 to eliminate duplicate received frames in both forwarding and non-forwarding devices. For example, if forwarding device B 812 is the initial transmitter of a frame onto PLC network segment 804, when forwarding device B 812 transmits the frame onto PLC network segment 804, forwarding device D 816 receives a copy of the frame because forwarding device D 816 can directly communicate with forwarding device B 812. However, since forwarding device D 816 is not an immediate neighbor to forwarding device B 812 with respect to the example routing tree 900, forwarding device D 816 can discard the frame received from forwarding device B 812. This is because forwarding device D 816 will receive a copy of the frame along the example routing tree 900 from forwarding device A 826. Likewise, when non-forwarding device G 824 originates a frame and transmits the frame onto PLC network segment 804, forwarding device A 826 receives a copy of the frame and can discard the copy because forwarding device A 826 will also receive a copy of the frame from forwarding device B 812. When forwarding device A 826 transmits a frame onto PLC network segment 804, non-forwarding device G 824 receives the frame and can discard it because forwarding device G 824 will also receive a copy of the frame from forwarding device B 812.

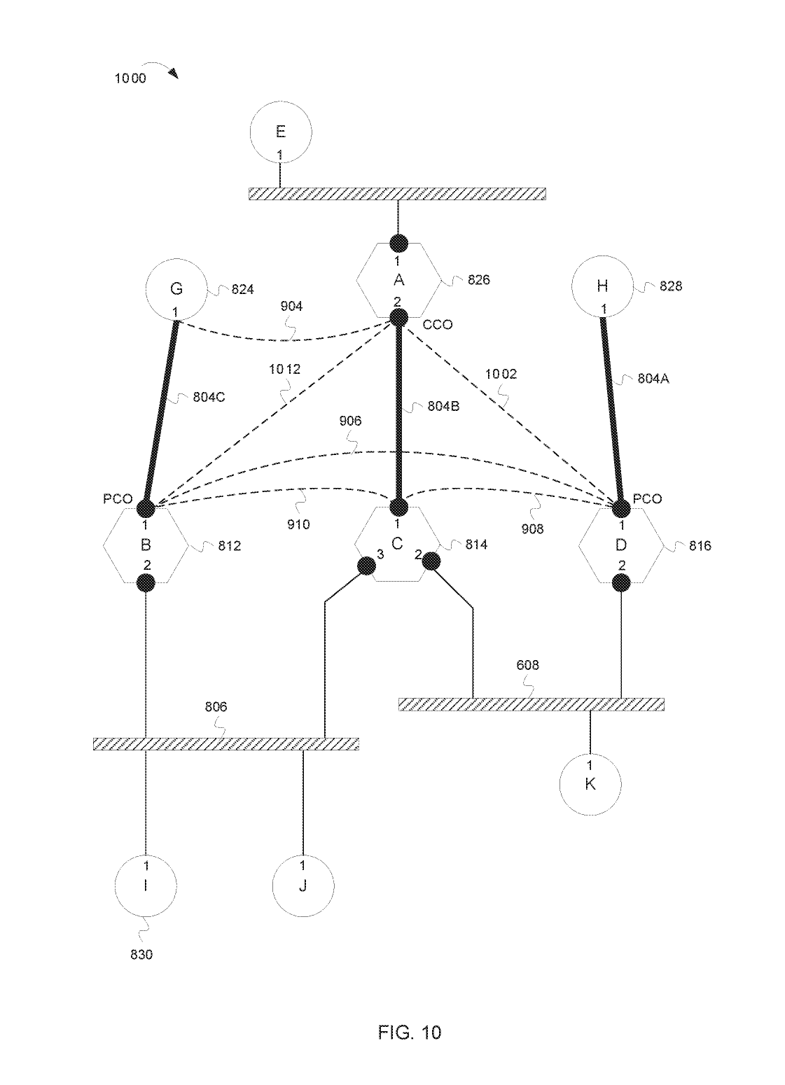

FIG. 10 is a block diagram illustrating an alternative example routing tree 1000 for the example network 800 of FIG. 8. In addition to the components illustrated in the example network 800 of FIG. 8, the example routing tree 1000 of FIG. 10 includes communication links 904, 906, 908, 910, 1002 and 1012. Communication links 904, 906, 908, 910, 1002 and 1012 are shown using dashed lines to represent communication links that are present in the physical network topology, but are not part of the example routing tree 1000 created from example network 800. Additionally, in the example routing tree 1000, the PLC network segment 804 is represented as three separate logical communication links 804A, 804B and 804C. Communication links 804A, 804B and 804C are logically distinct from the point of view of example routing tree 1000. However, based on the physical topology of example network 800, a broadcast frame transmitted from a network device on PLC network segment 804 can be received by any network device on the PLC network segment 804 that can reliably communicate with the transmitting network device.

The example routing tree 1000 illustrates a case where the same frame can be transmitted more than once on the same network segment. When multiple forwarding devices (i.e., bridges) are present on the same network segment, and more than one forwarding device forwards the same frame onto the network segment, it is possible for the same frame to be transmitted on the network segment more than once.

In the example routing tree 1000, none of the network interfaces are configured as frame relay network interfaces in example network 800. Connectivity between the network devices can be insured by using multiple forwarding devices. In the example illustrated in FIG. 10, the result can be that the same broadcast frame can be transmitted more than once on PLC network segment 804, and the conventional forwarding rule does not prevent loops, endlessly circulating frames, and duplicate received frames. For example, consider a broadcast frame that is first transmitted onto PLC network segment 804 by forwarding device A 826 via network interface A.2. The broadcast frame is received by all network devices that can reliably communicate with forwarding device A 826. Thus forwarding device C 814 receives the broadcast frame on network interface C.1. Forwarding device C 814 then forwards the broadcast frame via network interface C.2 to shared medium segment 608 (as well as to shared medium segment 806 via network interface C.3). Forwarding device D 816 receives the broadcast frame on network interface D.2 and forwards the broadcast frame back onto PLC network segment 804 via network interface D.1. Because forwarding device C 814 can reliably communicate with forwarding device D 816, forwarding device C 814 receives a second copy of the broadcast frame. However, using the method described above in FIG. 3, a frame filter 118 on forwarding device C 814 can determine that forwarding device D 816 is not an immediate neighbor network device according to example routing tree 1000. Therefore, forwarding device C 814 can discard the second copy of the broadcast frame, thereby preventing a loopback from occurring.

As will be appreciated by one skilled in the art, aspects of the present disclosure may be embodied as a system, method, or computer program product. Accordingly, aspects of the present disclosure may take the form of an entirely hardware embodiment, a software embodiment (including firmware, resident software, micro-code, etc.) or an embodiment combining software and hardware aspects that may all generally be referred to herein as a “circuit,” “module,” “unit,” or “system.” Furthermore, aspects of the present disclosure may take the form of a computer program product embodied in one or more machine-readable medium(s) having computer executable program code embodied thereon.

Any combination of one or more non-transitory machine-readable medium(s) may be utilized. Non-transitory machine-readable media comprise all machine-readable media, with the sole exception being a transitory, propagating signal. The non-transitory machine-readable medium may be a machine-readable storage medium. A machine-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the machine-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a machine-readable storage medium may be any tangible medium that can contain, or store a program for use by or in connection with an instruction execution system, apparatus, or device.

Computer program code embodied on a machine-readable medium for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), personal area network (PAN), or a wide area network (WAN), or the connection may be made to an external computer (for example, through the Internet using an Internet Service Provider).

Aspects of the present disclosure are described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a machine-readable medium that can direct a computer, other programmable data processing apparatus, or other devices to function in a particular manner, such that the instructions stored in the machine-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

While the embodiments are described with reference to various implementations and exploitations, it will be understood that these embodiments are illustrative and that the scope of the disclosure is not limited to them. In general, techniques for routing frames in networks that include shared medium segments as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the disclosure.

What is claimed is:

1. A method for forwarding frames, the method comprising:
receiving, by a first network device via a first network segment, a first frame having an initial transmitter identifier associated with a second network device that initially transmitted the first frame on the first network segment;
determining, by the first network device, a forwarding direction for the first frame based, at least in part, on the initial transmitter identifier, and a routing tree associated with a network topology; and
determining, based, at least in part, on the forwarding direction, an operation to perform for the first frame, wherein the operation comprises at least one member of the group consisting of discarding the first frame, processing the first frame, and forwarding the first frame.

2. The method of claim 1, further comprising:
determining to discard the first frame in response to determining that the forwarding direction is upstream to the second network device with respect to the routing tree.

3. The method of claim 1, further comprising:
determining to forward the first frame in response to determining that the forwarding direction is downstream from the second network device with respect to the routing tree.

4. The method of claim 1, further comprising:
setting the initial transmitter identifier of a second frame to a network device identifier of the first network device in response to determining that the second frame originates on the first network device.

5. The method of claim 1, further comprising:
preserving the initial transmitter identifier of the first frame in response to determining that the first network device is forwarding the first frame to the first network segment.

6. The method of claim 1, further comprising:
removing the initial transmitter identifier from the first frame in response to determining that the first network device is forwarding the first frame to a second network segment.

7. The method of claim 1, further comprising:
receiving, by the first network device via the first network segment, a second frame having a neighbor transmitter identifier associated with a third network device that transmitted the second frame on the first network segment;
determining, based at least in part on the neighbor transmitter identifier and the routing tree, that the third network device that the is not a neighbor network device; and
discarding the first frame in response to determining that the third network device is not a neighbor network device.

8. The method of claim 7, wherein the initial transmitter identifier and the neighbor transmitter identifier comprise at least one member of the group consisting of a value in a field in a frame header, a value in a virtual local area network (VLAN) tag in the frame header, and a value in a transmitter address field in the frame header.

9. A first network device for forwarding frames, the first network device comprising:
a processor;
a first network interface coupled to the processor, the first network interface to communicably couple the first network device to a first network segment; and
a machine-readable storage medium coupled to the processor, the machine-readable storage medium to store instructions, that when executed by the processor, cause the first network device to:
receiving, via the first network segment, a first frame having an initial transmitter identifier associated with a second network device that initially transmitted the first frame on the first network segment;
determine a forwarding direction for the first frame based, at least in part, on the initial transmitter identifier, and a routing tree associated with a network topology, and
determine, based at least in part on the forwarding direction, an operation to perform for the first frame, wherein the operation comprises at least one member of the group consisting of discard the first frame, process the first frame, and forward the first frame.

10. The first network device of claim 9, wherein the instructions to determine to discard the first frame comprise instructions to cause the first network device to:
determine to discard the first frame in response to a determination that the forwarding direction is upstream to the second network device with respect to the routing tree.

11. The first network device of claim 9, wherein the instructions to determine to discard the first frame comprise instructions to cause the first network device to:
determine to forward the first frame in response to a determination that that the forwarding direction is downstream from the second network device with respect to the routing tree.

12. The first network device of claim 9, wherein the instructions further cause the first network device to:
set the initial transmitter identifier of a second frame to a network device identifier of the first network interface in response to a determination that the second frame originates on the first network device.

13. The first network device of claim 9, wherein the instructions further cause the first network device to:
preserve the initial transmitter identifier of the first frame in response to a determination that the first network device is forwarding the first frame onto the first network segment.

14. The first network device of claim 9, further comprising a second network interface communicably coupled to the processor, and wherein the instructions further cause the first network device to:
remove the initial transmitter identifier from the first frame in response to a determination that the first network device is forwarding the first frame onto a second network segment communicably coupled to the second network interface.

15. The first network device of claim 9, wherein the instructions further cause the first network device to:
receive, via the first network segment, a second frame having a neighbor transmitter identifier associated with a third network device that transmitted the second frame on the first network segment;
determine, based at least in part on the neighbor transmitter identifier and the routing tree, that the third network device is not a neighbor network device to the first network interface; and
discard the first frame in response to a determination that the third network device is not a neighbor network device.

16. The first network device of claim 15, wherein the initial transmitter identifier and the neighbor transmitter identifier comprise at least one member of the group consisting of a value in a field in a frame header, a value in a virtual local area network (VLAN) tag in the frame header, and a value in a transmitter address field in the frame header.

17. The first network device of claim 9, wherein the first network interface comprises a wireless network interface.

18. The first network device of claim 9, wherein the first network interface is configured as a frame relay network interface.

19. A non-transitory machine-readable storage medium having stored thereon instructions, that when executed by a processor, cause a first network device to perform operations comprising:
receiving, via a first network segment, a first frame having an initial transmitter identifier associated with a second network device that initially transmitted the first frame on the first network segment;
determining a forwarding direction for the first frame based, at least in part, on the initial transmitter identifier, and a routing tree associated with a network topology; and
determining, based at least in part on the forwarding direction, an operation to perform for the first frame, wherein the operation comprises at least one member of the group consisting of discarding the first frame, processing the first frame, and forwarding the first frame.

20. The non-transitory machine-readable storage medium of claim 19, wherein the operations further comprise:
determining to discard the first frame in response to determining that that the forwarding direction is upstream to the second network device with respect to the routing tree.

21. The non-transitory machine-readable storage medium of claim 19, wherein the operations further comprise:
determining to forward the first frame in response to determining that that the forwarding direction is downstream from the second network device with respect to the routing tree.

22. The non-transitory machine-readable storage medium of claim 19, wherein the operations further comprise:
setting the initial transmitter identifier of a second frame to a network device identifier of the first network device in response to determining that the second frame originates on the first network device.

23. The non-transitory machine-readable storage medium of claim 19, wherein the operations further comprise:
preserving the initial transmitter identifier of the first frame in response to determining that the first network device is forwarding the first frame to the first network segment.

24. The non-transitory machine-readable storage medium of claim 19, wherein the operations further comprise:
removing the initial transmitter identifier from the first frame in response to determining that the first network device is forwarding the first frame to a second network segment.

25. The non-transitory machine-readable storage medium of claim 19, wherein the operations further comprise:
receiving, via the first network segment, a second frame having a neighbor transmitter identifier associated with a third network device that transmitted the second frame on the first network segment;
determining, based at least in part on the neighbor transmitter identifier and the routing tree, that the third network device is not a neighbor network device to the first network device; and
discarding the first frame in response to determining that the third network device is not a neighbor network device.

26. The non-transitory machine-readable storage medium of claim 25, wherein the initial transmitter identifier and the neighbor transmitter identifier comprise at least one member of the group consisting of a value in a field in a frame header, a value in a virtual local area network (VLAN) tag in the frame header, and a value in a transmitter address field in the frame header.

27. A method for forwarding frames, the method comprising:
determining, at a first network device and based at least in part on a routing tree, that a second network device from which a frame was received is not a neighbor network device; and
discarding, by the first network device, the frame in response to determining that the second network device is not a neighbor network device.

28. The method of claim 27, wherein the routing tree comprises a spanning tree.

29. The method of claim 27, wherein determining that the second network device is not a neighbor network device is based, at least in part, on a neighbor transmitter identifier in a frame header of the frame.

30. The method of claim 27, wherein the frame is received via a network segment, and wherein the method further comprises:
determining, by the first network device, a forwarding direction for the frame based, at least in part, on an initial transmitter identifier in a frame header of the frame, the initial transmitter identifier associated with a third network device that initially transmitted the frame on the network segment, and the routing tree; and
determining, by the first network device, whether to discard or forward the frame based, at least in part, on the forwarding direction.
